(19) United States
(12) Patent Application Publication
(10) Pub. No.: US 2007/0208673 A1
(43) Pub. Date: Sep. 6, 2007

(54) Method and system for increasing sales of digital product modules

(75) Inventors: Amos Maggor, Tel Aviv (IL); Yank Margalit, Ramat Gan (IL); Dany Margalit, Ramat Gan (IL)

Correspondence Address: DR. MARK FRIEDMAN LTD.;C/o Bill Polkinghorn, 9003 Florin Way, Upper Marlboro, MD, 20772, US

(73) Assignee: ALADDIN KNOWLEDGE SYSTEMS LTD.

(21) Appl. No.: 11/363,059

(22) Filed: Feb. 28, 2006

(51) Int. Cl. G06F 17/00

(52) U.S. Cl. 705/404

(57) ABSTRACT

A method for selling a digital product (software, multimedia object, and so forth) having a plurality of modules to a customer, the method comprising the steps of: upon closing a deal with the customer where a first group of the modules have been purchased by the customer and a second group of the modules have not been purchased by the customer: installing the first group of the modules at the customer's site; installing the second group of the modules at the customer's site such that at least one of the modules of the second group is protected by a protection mechanism; monitoring the use of each of the protected modules for indicating the modules as valuable to the customer; upon indicating a module as valuable to the customer: employing an automatic salesman for selling the valued module to the customer.

### FIELD OF THE INVENTION

The present invention relates to the field digital products marketing. More particularly, the present invention relates to a method and system for increasing sales of modules of a digital product.

### BACKGROUND OF THE INVENTION

The term “digital product” refers herein as to any digital medium that comprises a plurality of modules.

The term “module of a digital product” refers herein as to a part or a feature of a digital product which can be added to the digital product without presence of a technical person at the usage site.

For example, Microsoft Office is a digital product. It comprises a plurality of modules, such as Word, Excel, Power Point, etc.

Additional example: Microsoft Word is a digital product whose modules are the editing module, the spell checker, etc.

Additional example: A database of multimedia files is a digital product. Its sound files can be considered as a module, and its video files can be considered as another module. Also the categories of the files of the digital product, such as rock music, classic music, etc., can be considered as modules of the digital product.

FIG. 1 schematically illustrates a method for selling a digital product having a plurality of modules, according to the prior art.

Purchasing a digital product may be carried out in a plurality of stages, especially if the customer is an organization. At the “primary stage”, the salesman spends his time at the potential customer, demonstrating the digital product he sells. Finally, he closes a deal with the potential customer.

A deal in which a digital product has been sold may comprise two options: (a) the customer has purchased all the modules of the digital product; and (b) the customer has not purchased all the modules of the product.

In case where the customer has not purchased all the modules of the product, the sale continues to a secondary stage, in which the salesman returns to the customer after a while, and tries to sell him the modules which he has not purchased in the first time. This stage is referred herein as to the “secondary stage”.

The secondary stage requires utilizing additional “selling resources” (i.e. time of the salesman) for selling modules which the salesman has failed to sell in the primary stage. In order to spare the resources required for the secondary stage, the salesman may decrease the price of the modules he has not managed to sell, in order to sell all the modules without utilizing additional selling resources.

It is an object of the present invention to provide a method for selling modules which have not been soled at the first time, without utilizing additional selling resources.

Other objects and advantages of the invention will become apparent as the description proceeds.

### SUMMARY OF THE INVENTION

A method for selling a digital product (software, multimedia object, and so forth) having a plurality of modules to a customer, the method comprising the steps of: upon closing a deal with the customer where a first group of the modules have been purchased by the customer and a second group of the modules have not been purchased by the customer: installing the first group of the modules at the customer's site; installing the second group of the modules at the customer's site such that at least one of the modules of the second group is protected by a protection mechanism; monitoring the use of each of the protected modules for indicating the modules as valuable to the customer; upon indicating the module as valuable to the customer: employing an automatic salesman for selling the module to the customer.

The protection mechanism performs operations such as preventing unauthorized use of the module, slowing down the operation speed of the module, slowing down the operation speed of the module as the time passes (or the use increases), increasing the amount of pop-up messages per time period, preventing the module from saving wok that has been done with it, terminating the operation of the module, and so forth. For example, the protection mechanism may comprise software modules, hardware modules, a protection dongle, and so forth.

Monitoring the use can be carried out by monitoring the value of one or more parameters that have relevance to the use, such as the number of times the module has been activated during a time period, the time a module has been in use during a time period, the number of hits on a user interface of the module per time period, and so forth. The parameter may have a direct connection or indirect connection with the use.

According to one embodiment of the invention, indicating the module as valuable to the customer is carried out by the steps of: predefining a threshold of at least one monitored parameter; and monitoring the value of the at least one parameter; upon exceeding the value of the at least one parameter beyond the threshold, indicating the module as valuable to the customer.

According to a preferred embodiment of the invention, installing the second group of the modules at the customer's site such that at least one of the modules of the second group is protected by a protection mechanism is agreed between the salesman and the user.

A customer may be an organization, an individual, and so forth.

According to one embodiment of the invention, selling the module to the customer comprises restricting the functionality of the module in order to tempt the customer to buy the module. The restriction may be progressive, such as slowing down the speed operation of the module as the time passes, slowing down the speed operation of the module as the use increases, increasing the amount of pop-up messages per time period, preventing the module from saving a snapshot of work that has been done with it, and so forth. The restriction may be carried out using means such as hardware means, software means, a protection dongle, product activation, and so forth.

### BRIEF DESCRIPTION OF THE DRAWINGS

The present invention may be better understood in conjunction with the following figures:

FIG. 1 schematically illustrates a method for selling a digital product having a plurality of modules, according to the prior art.

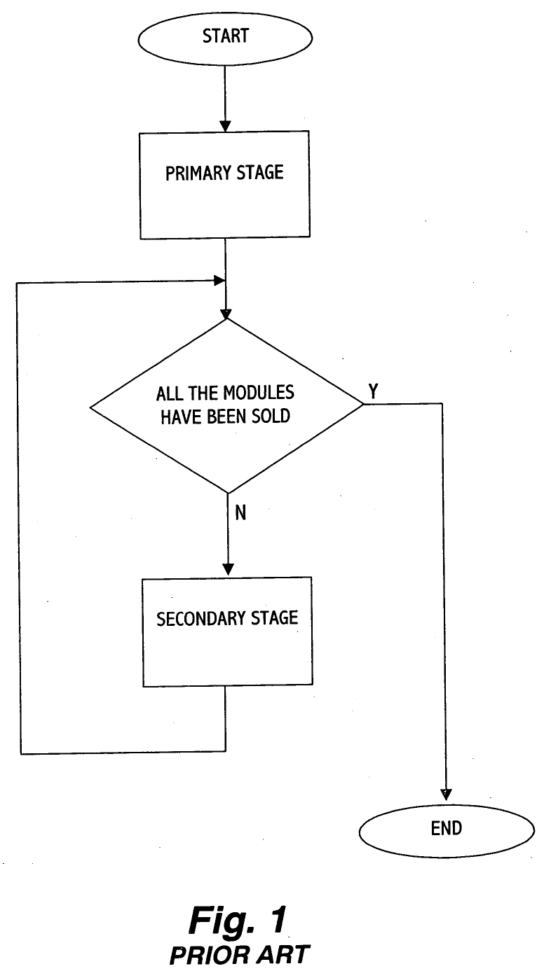

FIG. 2 schematically illustrates a method for selling a digital product having a plurality of modules, according to a preferred embodiment of the invention.

FIG. 3 schematically illustrates a method for indicating that a module is valuable to a user thereof, according to a preferred embodiment of the invention.

### DETAILED DESCRIPTION OF PREFERRED EMBODIMENTS

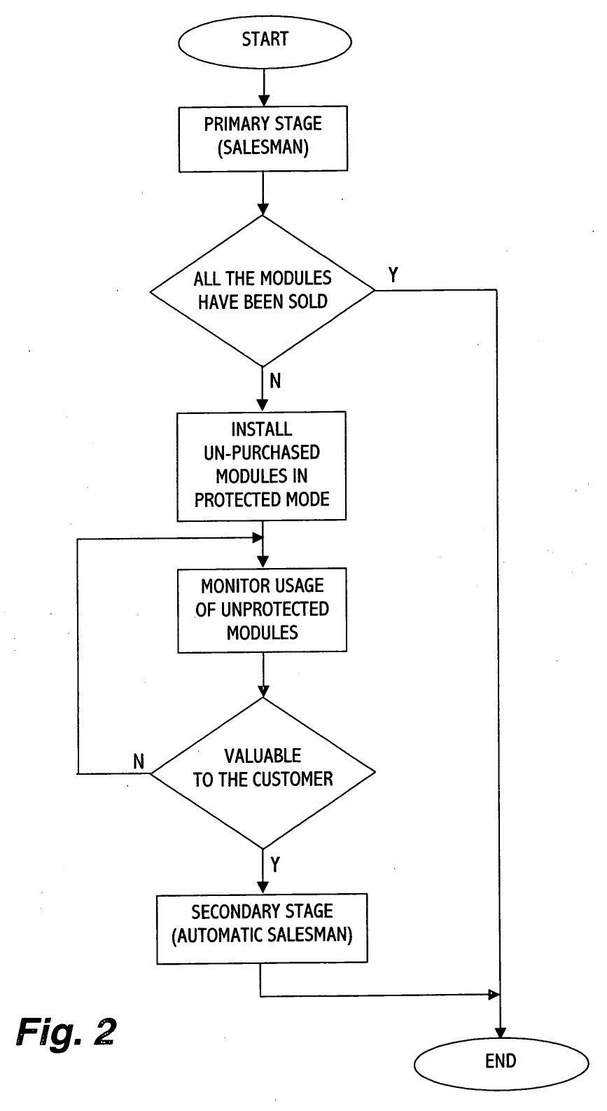

FIG. 2 schematically illustrates a method for selling a digital product having a plurality of modules, according to a preferred embodiment of the invention.

According to this embodiment, after a salesman has closed a deal in which only a part of the available modules of a digital product have been sold to a customer, the salesman offers the customer a “gift”: to install at the customer's site one or more of the unsold modules for a trial. However, the trial is under a condition: the gift modules will be installed in a protected mode, which allows monitoring the use of the modules and controlling the functionality of these modules.

During the next period (weeks, months, etc.) the use of the unsold modules is monitored by the protection mechanism. If one or more of the trial modules appears to be useful for the customer, an “automatic salesman” tries to sell this module to the customer as follows:

The term “automatic salesman” refers herein to a mechanism for persuading a customer to buy a product. The word “automatic” denotes that this function is carried out by a machine, in contrast to a human being.

The automatic salesman may persuade the customer to buy a module by presenting to the user thereof pop-up messages in which he is notified that the module has been indicated as valuable to him, to inform a remote mechanism about the fact that the module has been indicated as valuable to the customer, to send from the remote mechanism email which offers to the customer a deal, etc.

In addition the automatic salesman can instruct the protection mechanism which controls the module to restrict the functionality of the module. According to one embodiment of the invention, restricting the use of the module is carried out by restricting some functionalities of the module. According to another embodiment of the invention, restricting the use of the module is carried out by ceasing the operation of the module.

According to one embodiment of the invention, the restriction is progressive. For example, slowing down the speed operation of the module as the time passes (or the use increases), increasing the amount of pop-up messages per time period, preventing the module from saving a snapshot of the work that has been done with it, etc.

According to a preferred embodiment of the invention, the way the restriction will be carried out is agreed between the human salesman and the potential customer at the stage where the salesman offers to the customer the “gift”.

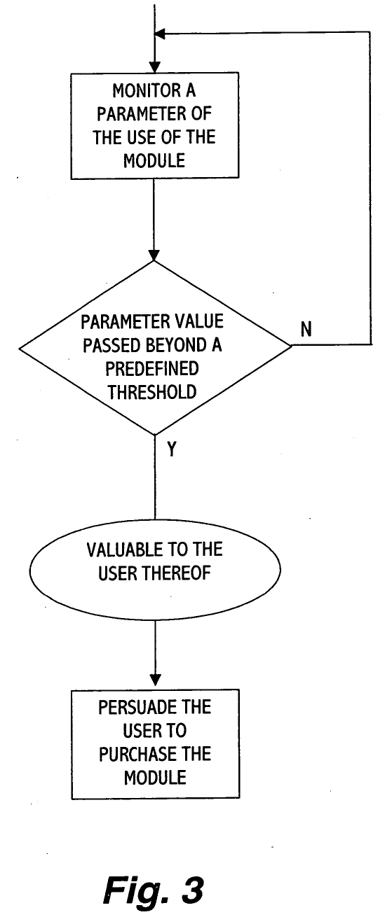

FIG. 3 schematically illustrates a method for indicating that a module is valuable to a user thereof, according to a preferred embodiment of the invention.

According to this embodiment, one or more parameters which have relevance to the use are monitored. Examples of such parameters include the number of times a module has been activated during a time period (e.g. per day), for how long a module has been used during a time period, the number of hits (clicks) on a user interface of the module per time period, etc.

The parameters may have a direct connection with the use of the unsold modules, or indirect connection with this use. Activating an unsold module more than a certain number of times is an example for direct connection with the use of the unsold module. However, if the parameter is an increase of 20% of the sales of a certain product, not necessarily the one which the unsold modules belongs to, and it is assumed that the increase is due to the use of an unsold module, then the connection between the unsold module and the monitored parameter is indirect.

From a technical point of view, the parameter may be a value stored within certain memory storage of the customer's system, possibly but not necessarily of the unsold modules.

Once in a while (e.g., once a day) the parameter value is compared with a threshold thereof. If the parameter has passed beyond the threshold, it indicates intensive work with the module, which means that the module is valuable to the user thereof.

According to one embodiment of the invention, a combination of two or more monitored parameters may be used for indicating if the module is valuable to the user thereof. For example, if the module has been activated more that 100 times during a month, and if the average time the module was used is 1 hour, it indicates that the module is valuable to the user thereof.

After the customer has purchased the module, the protection may be removed from the module or adjusted such that the user is able to use the module without restrictions.

According to a preferred embodiment of the invention, protecting a module from unauthorized use is carried out by a “protection dongle”.

A “protection dongle” is a peripheral device to a computer, which is used for protecting software from unauthorized use. The HASP® family, manufactured by the present applicant, is an example of protection dongle. HASP HL® is a USB hardware key or dongle based cross-platform software copy protection solution that may be used for protecting intellectual property including software from unauthorized use or copy. It supports multiple software licensing models. It provides strong software protection based on AES and RSA algorithms, licensing models implemented independently of protection, single and multi-user license management, intuitive, easy to use HASP Envelope and API integration, cross-platform key that is ISO 9001:2000 accredited, ensuring the highest standards of reliability, and more. It uses an on-chip encryption engine, a 128-bit AES encryption algorithm, a cross-platform USB, key memory. It can be used for protection and licensing separated—change licensing models without having to re-protect or re-QA products. It supports automatic tools (HASP Envelope) for wrapping and protecting applications including Microsoft Net, universal and cross-platform API, license generator (HASP Factory) for defining licenses and terms, remote update system, integration of license information into CRM and ERP systems.

Employing a protection dongle in order to protect modules which have been provided to a user for trial is a simple solution, since a software vendor or manufacturer, and even a digital content provider doesn't have to deal with the protection logic. The dongle can perform all the monitoring activities, and also to cause the module to cease its operation.

According to a preferred embodiment of the invention, protecting a module from unauthorized use is carried out by a “network dongle”. HASP HL Net® manufactured by the present applicant is an example for network dongle used for protecting intellectual property including software running in network environments. A single HASP HL Net® key, connected to any computer in a network, provides flexible 3-way software protection. It limits the number of users who can access a user's application concurrently, and controls access of up to 112 different software modules and packages. For example, using this product licenses can limit concurrent users, it has 4 KB of secured memory, a unique 32 bit ID number, multiple (112) license capacity, remote update of keys in the field with RSA signature, on-chip encryption engine, a 128-bit AES Encryption Algorithm, a Universal API, a Windows Update support, a Cross-platform USB. It is based on HASP HL Max®. HASP HL Net® supports Netware, Microsoft Network and LANs based on SPX/IPX, NetBIOS, and TCP/IP protocols.

The benefits of the present invention are:
90% to 95% of Software developers worldwide object protecting the software they sell. The Automatic Salesman (AS) often is the right solution for them.
The present invention may be implemented by the means of a protection dongle, with all the benefits thereof.
The present invention detects when the unsold modules create value at the customer's site.
When the value of an unsold module passes a certain agreed limit, it automatically switches on and sends agreed messages.
The human salesman does not need to devote extra time to persuading the potential customer to buy the trial modules.
The method provides to a customer an objective tool for indicating its value to the customer, which may help the customer to decide upon modules of whose importance to him he is not sure.
The present invention points out on the exact moment when the customer is available to purchase a module.
The ROI (Return On Investment) for the additional protection facility (e.g. protection dongle) comes by dramatic efficiency leverage for the sales team.
It is a smart way to make additional sales into a customer base.

Those skilled in the art will appreciate that the invention can be embodied in other forms and ways, without losing the scope of the invention. The embodiments described herein should be considered as illustrative and not restrictive.

1. A method for selling a digital product having a plurality of modules to a customer, the method comprising the steps of:
upon closing a deal with said customer where a first group of said modules have been purchased by said customer and a second group of said modules have not been purchased by said customer:
installing said first group of said modules at said customer's site;
installing said second group of said modules at said customer's site such that at least one of the modules of said second group is protected by a protection mechanism;
monitoring the use of each of the protected modules for indicating said modules as valuable to said customer;
upon indicating one of said modules as valuable to said customer:
employing an automatic salesman for selling said one module to said customer.

2. A method according to claim 1, wherein said protection mechanism performs at least one operation selected from the group comprising: preventing unauthorized use of said protected modules, slowing down the operation speed of said protected modules, slowing down the operation speed of said protected modules as the time passes, slowing down the operation speed of said protected modules as the use thereof increases, increasing the amount of pop-up messages per time period, preventing the protected modules from saving work that has been done therewith, terminating the operation of an protected module. 1670

3. A method according to claim 1, wherein said protection mechanism is selected from the group comprising: software, hardware, a protection dongle.

4. A method according to claim 4, wherein said monitoring the use comprises monitoring the value of one or more parameters that have relevance to the use.

5. A method according to claim 4, wherein said one or more parameters is selected from the group comprising: a number of times each said protected module has been activated during a time period, the time a said protected module has been in use during a time period, the number of hits on a user interface of a said protected module per time period.

6. A method according to claim 4, wherein at least one of said parameters has direct connection with said use.

7. A method according to claim 4, wherein at least one of said parameters has indirect connection with said use.

8. A method according to claim 1, wherein said indicating said one module as valuable to said customer is carried out by the steps of:
predefining a threshold to at least one monitored parameters;
monitoring the value of said at least one parameter; and
upon the value of said at least one parameter exceeding said threshold, indicating said one module as valuable to said customer.

9. A method according to claim 1, wherein said installing of said second group of said modules at said customer's site is effected such that at least one of the modules of said second group is protected by a protection mechanism is agreed between said salesman and said user.

10. A method according to claim 1, wherein said customer is selected from a group comprising: an organization.

11. A method according to claim 1, wherein said customer is selected from a group comprising: an individual.

12. A method according to claim 1, wherein said selling said module to said customer by said automatic salesman comprises restricting the functionality of said module in order to temp said customer to buy said module.

13. A method according to claim 12, wherein the restricting is progressive.

14. A method according to claim 12, wherein the progressive restricting is by a method selected from a group comprising: slowing down the speed operation of said module as the time passes, slowing down the speed operation of said module as the use of said module increases, increasing the amount of pop-up messages per time period, preventing the module from saving a snapshot of work that has been done therewith.

15. A method according to claim 12, wherein said restricting is carried out using means selected from a group comprising: hardware means, software means, a protection dongle, product activation.

16. A method according to claim 12, wherein said digital product is selected from the group comprising: software, a data file.
